(19) United States
(12) Patent Application Publication
(10) Pub. No.: US 2017/0262780 A1
(43) Pub. Date: Sep. 14, 2017

(54) ADJUSTABLE ROBUST OPTIMIZATION FOR PROCESS EXECUTION

(71) Applicant: International Business Machines Corporation, Armink, NY (US)

(72) Inventors: Odellia Alfassi Boni, Haifa (IL); Michael Masin, Haifa (IL); Evgeny Shindin, Nesher (IL)

(21) Appl. No.: 15/068,665

(22) Filed: Mar. 14, 2016

(51) Int. Cl. G06Q 10/06

(52) U.S. Cl. CPC G06Q 10/06375; G06Q 10/067

(57) ABSTRACT

A computer implemented method of optimizing an execution of a process by applying adjustable robust optimization, comprising:
1) Designating an optimization function for calculating an optimal solution for a process execution comprising a plurality of ordered events. The process execution depends on a plurality of uncertain variables.
2) Identifying an adjustment which sets a value for one or more adjusted variables of the plurality of uncertain variables. The adjustment is derived from one or more decisions made by a user. The one or more decisions define an order of one or more ordered events to execute a particular realization of the process execution.
3) Applying the one or more adjusted variables to the optimization function which calculates the optimal solution.
4) Outputting the optimal solution to the user.

### BACKGROUND

The present invention, in some embodiments thereof, relates to optimizing an execution of a process, and, more specifically, but not exclusively, to optimizing an execution of a process by applying adjustable robust optimization.

Real-world optimization problems typically involve at least some level of uncertainty of data required for the optimization process. Naturally, the data uncertainty may significantly affect the quality of the nominal solution(s).

To overcome the data uncertainty, robust optimization (RO) methodology may be used to calculate an optimal solution for a plurality of optimization problems where the data uncertainty can be represented through deterministic variability in the value of the parameters of the problem itself and/or its solution. Specifically, the RO methodology may be applied to optimization problems where one can separate uncertain numerical data from the problem's structure.

The RO methodology employs chance, probabilities of the variables uncertainty and robust constraints to generate a robust solution which may be immunized against the effect(s) of data uncertainty. The RO methodology identifies a computational tractable optimization problem which an approximation robust counterpart (RC) of the original problem and for which an optimal solution may be calculated that meets the constraints of the original optimization problem.

However, for many types of optimization problems, in particular for real life problems the data uncertainty may be viewed as comprising real uncertain variables induced by real (external) uncertainty sources and state uncertain variables which depend on events and/or elements that are part of the optimization problem structure and/or the designated RO model itself. While there is little and/or no control over the real variables, one or more of the state variables may be adjusted thus relaxing the constraints and allow using approximated adjusted robust counterparts (ARC) and/or affine ARC (AARC) to solve the optimal solution.

### SUMMARY

According to some embodiments of the present invention there are provided methods for optimizing an execution of a process by applying adjustable robust optimization, comprising of:

Designating an optimization function for calculating an optimal solution for a process execution comprising a plurality of ordered events. The process execution depends on a plurality of uncertain variables.
Identifying an adjustment which sets a value for one or more adjusted variables of the plurality of uncertain variables. The adjustment is derived from one or more decisions made by a user. The one or more decisions define an order of one or more of the ordered events to execute a particular realization of the process execution.
Applying the one or more adjusted variables to the optimization function which calculates the optimal solution.
Outputting the optimal solution to the user.

Each of the plurality of uncertain variables is defined with a probability value.

The optimized solution resides within a set of pre-defined constraints.

The optimization function is calculated using one or more robust optimization models.

Optionally, a robustness of the optimization function is improved by applying one or more predicted adjusted variables to the optimization function. The one or more predicted adjusted variables are derived from one or more simulated realizations of the process execution.

According to some embodiments of the present invention there are provided systems for optimizing an execution of a process by applying adjustable robust optimization, comprising, an interface for communicating with a user, a program store storing a code and one or more processors coupled to the interface and the program store for executing the stored code. The code comprising:
Code instructions for designating an optimization function for calculating an optimal solution for a process execution comprising a plurality of ordered events. The process execution depends on a plurality of uncertain variables.
Code instructions for identifying an adjustment which sets a value for one or more adjusted variables of the plurality of uncertain variables. The adjustment is derived from one or more decisions made by a user. The one or more decisions define an order of one or more of the ordered events to execute a particular realization of the process execution.
Code instructions for applying the one or more adjusted variables to the optimization function which calculates the optimal solution.
Code instructions for outputting the optimal solution to the user.

Optionally, the code includes code instructions for improving a robustness of the optimization function by applying one or more predicted adjusted variables to the optimization function. The one or more predicted adjusted variables are derived from one or more simulated realizations of the process execution.

According to some embodiments of the present invention there are provided computer program products for optimizing an execution of a process by applying adjustable robust optimization, comprising:
A non-transitory computer readable storage medium.
First program instructions to designate an optimization function for calculating an optimal solution for a process execution comprising a plurality of ordered events. The process execution depends on a plurality of uncertain variables.
Second program instructions to identify an adjustment which sets a value for one or more adjusted variables of the plurality of uncertain variables. The adjustment is derived from one or more decisions made by a user. The one or more decisions define an order of one or more of the ordered events to execute a particular realization of the process execution.
Third program instructions to apply the one or more adjusted variables to the optimization function which calculates the optimal solution.
Fourth program instructions to output the optimal solution to the user.

Wherein the first, second, third and fourth program instructions are executed by one or more processors from the non-transitory computer readable storage medium.

Optionally, the computer program product comprises fifth program instructions to improve a robustness of the optimization function by applying one or more predicted adjusted variables to the optimization function. The one or more predicted adjusted variables are derived from one or more simulated realization of said process execution.

### BRIEF DESCRIPTION OF THE SEVERAL VIEWS OF THE DRAWINGS

Some embodiments of the invention are herein described, by way of example only, with reference to the accompanying drawings. With specific reference now to the drawings in detail, it is stressed that the particulars shown are by way of example and for purposes of illustrative discussion of embodiments of the invention. In this regard, the description taken with the drawings makes apparent to those skilled in the art how embodiments of the invention may be practiced.

In the drawings:

FIG. 1 is a flowchart of an exemplary process for optimizing an execution of a process using adjustable robust optimization, according to some embodiments of the present invention; and

FIG. 2 is a schematic illustration of an exemplary system for optimizing an execution of a process using adjustable robust optimization, according to some embodiments of the present invention.

### DETAILED DESCRIPTION

The present invention, in some embodiments thereof, relates to optimizing an execution of a process, and, more specifically, but not exclusively, to optimizing an execution of a process by applying adjustable robust optimization.

According to some embodiments of the present invention, there are provided methods, systems and computer program products for optimizing an execution of a process by applying adjustable robust optimization. The optimization process for calculating an optimal solution for an execution of a process comprising a plurality of ordered events is based on RO methodology and specifically an ARC model as known in the art since the process execution and/or process scheduling typically involve data uncertainty which may significantly affect the optimal solution. The optimal solution is calculated with respect to a plurality of constraints defining the solution space for the process execution and/or process scheduling. For optimization problems, in particular for real life problems such as process execution and/or scheduling the data uncertainty may be viewed as comprising of real uncertain variables induced by real (external) uncertainty sources and state uncertain variables which depend on events and/or elements that are part of the process execution structure and/or the designated ARC model itself. The uncertain variables, both real and state variables are each defined with a probability value. As discussed before, while there is little and/or no control over the real variables, one or more of the state variables may be adjusted during the process execution. One or more of the adjustable state variables may become available during the process execution as result of one or more aspects, for example, decisions which are made during the process execution, for example, setting an order of events, setting an order of tasks and/or allocating resources.

As opposed to traditional RO and/or ARC methodologies the optimization process presented herein is directed towards a decision based optimization process in which one or more of the adjustable state variables are adjusted by taking decision(s) during the process execution. This means that one or more of the state variables may become available (uncertainty removed) by allowing user(s) to take one or more decisions to define a realization path of the process execution. The one or more now available state variables (adjusted variables) are applied back into the optimization process resulting in an improved ARC optimization process in which the optimization process relies on a lesser level of uncertainty compared to the designated RO process. Furthermore, one or more possible decisions may be analyzed in advance and introduced back into the optimization process in order to improve and/or refine the designated ARC model on which the optimization process is based.

The optimization process presented herein may present significant advantages compared to traditional and/or classical RO and/or ARC models. The RO use pre-defined precedence information which relates to specific one or more past events of the process execution for calculating the optimal solution, however the RO may not use future information of events which have not yet occurred. This may lead to over-conservative requirements which may result in typical-case bad solutions and/or or even empty solution spaces. The presented optimization process may overcome this drawback by using state variable(s) that become known (uncertainty removed) at some point during the process execution since a specific realization of the execution process was decided on by a user in real time. Furthermore, while the original uncertain design problem may be a mixed integer linear problem (MILP), the approximated ARC can be non-linear. Non-linear problems may present major difficulties to solve using available optimization tools. Reducing the uncertainty level may allow formulating the ARC models in linear formulation(s). Another advantage may relate to the RO methodology requirement for all uncertain variables to be identified and/or independent of the problem structure. This requirement may present a major challenge for real life problems in which the state variables may not be explicitly available and/or separated from the problem structure. By directing and/or associating between the decision(s) and one or more of the state variables, the explicitly level for identifying the state variables is increased thus improving the optimization function robustness. While the improved robustness may be at the expense of applying new constraints to the optimization problem, the flexibility and/or explicitly of the uncertain variables may prove to be much more valuable.

The optimization process starts with designating an RO, specifically an ARC and/or an AARC optimization function for calculating an optimal solution for the process execution and specifically a process scheduling which includes a plurality of ordered events and comprising a plurality of uncertain variables. The optimal solution is calculated with respect to a plurality of constraints defining the solution space for the process execution. The optimization process proceeds during runtime of the process execution and follows a specific realization path of the process execution. The specific realization path may be defined by one or more decisions made by a user and/or an automated tool. By following a specific realization path of the process execution, one or more of the state variables may be adjusted (become available), i.e. be assigned a value as they may be derived from the specific realization path. The one or more available state variables are applied back into the optimization function thus reducing the uncertainty level of the data used by the optimization function.

Optionally, the designated optimization function is applied with one or more predicted adjusted state variables. The predicted adjusted state variables may be derived from one or more predicted decisions, i.e. decision(s) that are likely and/or have a probability value of occurring during the runtime of the process execution. The predicted adjusted state variable(s) may further improve the robustness of the optimization function and hence the calculated optimal solution.

Before explaining at least one embodiment of the invention in detail, it is to be understood that the invention is not necessarily limited in its application to the details of construction and the arrangement of the components and/or methods set forth in the following description and/or illustrated in the drawings and/or the Examples. The invention is capable of other embodiments or of being practiced or carried out in various ways.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wire line, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

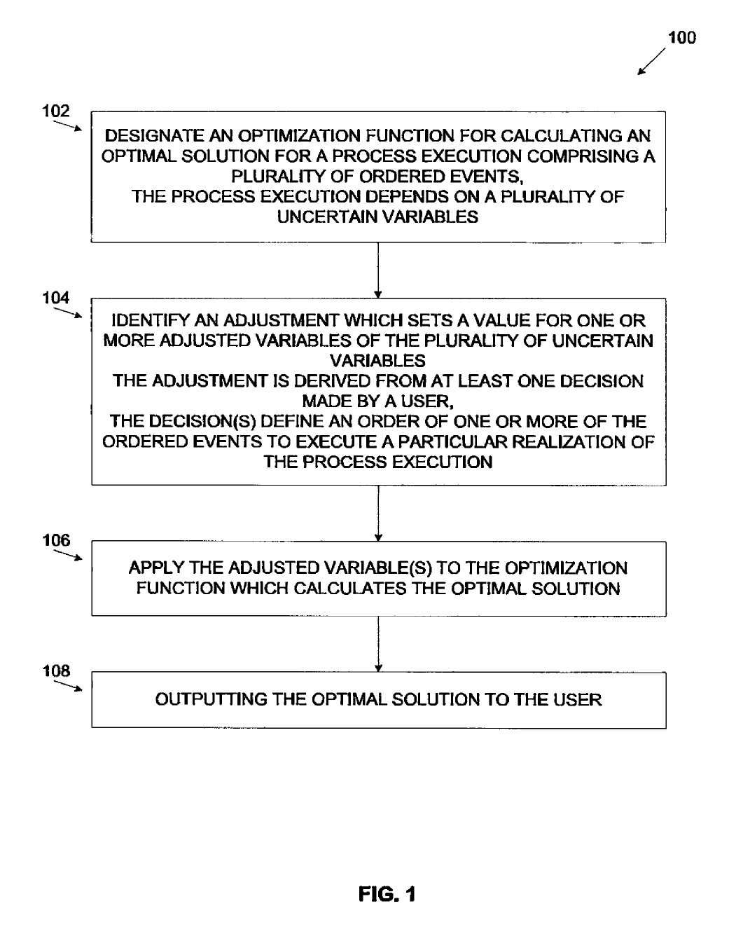

Reference is now made to FIG. 1 which is a flowchart of an exemplary process for optimizing an execution of a process using adjustable robust optimization, according to some embodiments of the present invention.

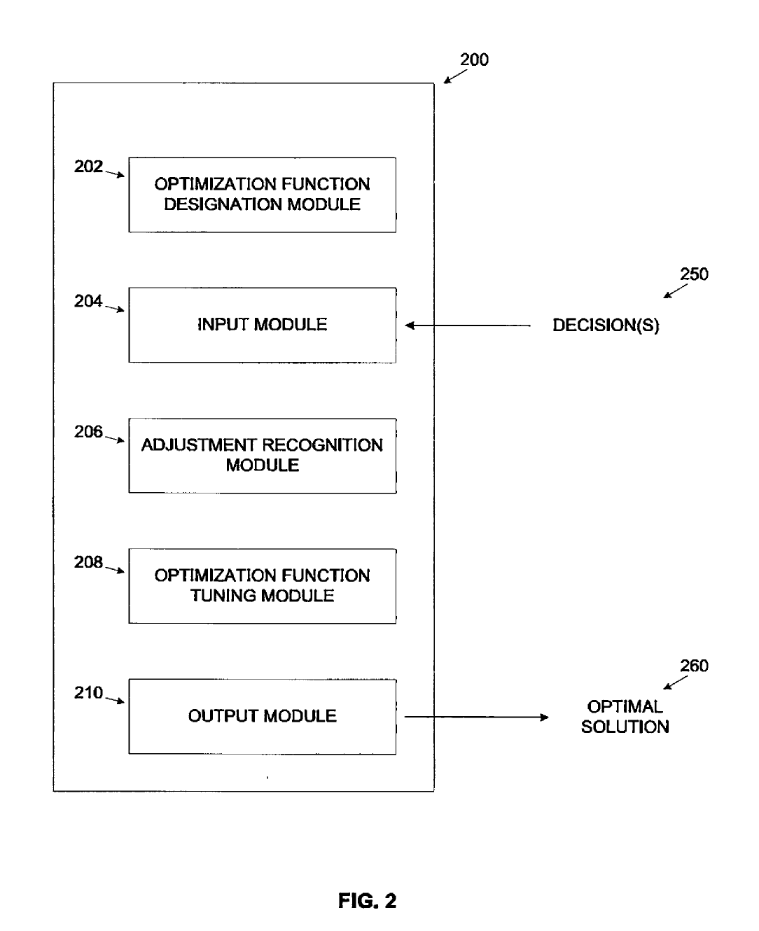

Reference is also made to FIG. 2 which is a schematic illustration of an exemplary system for optimizing an execution of a process using adjustable robust optimization, according to some embodiments of the present invention. A system 200 includes an optimization function designation module 202 for designating an optimal solution for a process execution and/or process scheduling problem, an input module 204, an adjustment identification module 206, an optimization function tuning module 208 and an output module 210 for outputting an optimal solution 260. Wherein a module refers to a plurality of program instructions stored in a non-transitory medium and executed by one or more processors and/or one or more cores of one or more processors. The input module 204 and output module 210 may include one or more of a plurality of interfaces, for example, a user interface such as, for example, a graphical user interface (GUI) and/or a network interface for communicating with one or more remote devices. The interface(s) of the module 204 and output module 210 may be used for interacting with one or more local and/or remote users and/or automated tools. The system 200 may be used for executing an optimization process such as the optimization process 100.

As shown at 102, a process 100 for optimizing a process execution, specifically a process scheduling starts with designating an RO, specifically an ARC optimization function for calculating an optimal solution for the process execution. The RO based ARC and/or AARC optimization methodology is selected since the process execution includes a plurality of ordered events and depends on a plurality of uncertain variables originating from a plurality of uncertainty sources. Each of the plurality of uncertain variables is defined with a probability value. The optimal solution for process execution must comply with a plurality of constraints imposed on the process execution. The uncertain variables may be classified as uncertain “real” variables originating from “real” uncertainty sources, for example, type of resource(s) to be used or uncertain “state” variables which depend on a realization path of the process execution, for example, an order of events, allocation of resources and the likes. The optimization function designation module 202 may be used to designate the appropriate optimization function for the process execution, specifically the process scheduling problem.

As shown at 104, adjustments to one or more of the state variables (adjusted variables) may be identified during the runtime of the process execution. While there is little and typically no control over the real variables, the state variables which are derived from the specific realization path of the process execution may be affected by one or more runtime decisions defining the realization path. The adjusted variables may therefore be assigned with a value and become available (eliminate uncertainty) following one or more decisions 250 defining the realization path of the process execution. Using the runtime decisions for reducing uncertainty of one or more other adjustable state variables may be regarded as transforming one or more of the adjustable state variables to decision variables. The decision(s) 250 may be received by the input module 204 providing and input interface for one or more users and/or automated tools. The received decision(s) 250 may define one or more aspects and/or realizations of the process execution, for example, an order of one or more of the ordered events, allocation of resources for one or more tasks performed during one or more of the ordered events and the likes. The value of the one or more adjusted variables which may become available following the decision(s) 250 may be identified by the adjustment recognition module 206.

As shown at 106, the adjusted variable(s) are applied back into the optimization function designated for calculating the optimal solution for the process execution problem. The optimization process 100 therefore takes into account a decision based model and adjusts accordingly the adjustable state variable(s) used by the optimization function thus reducing the uncertainty level of the process execution problem to provide a more robust optimal solution compared to legacy RO optimization methodology approach. The optimization function tuning module 208 may be used to apply the adjusted variable(s) to the optimization function for tuning the optimization function according to the realization path defined by the received decision(s) 250.

As shown at 108, the optimal solution 260 which is tuned and/or adjusted to provide a more robust result is provided to the user(s). The optimal solution 260 may be provided through the output module 210.

Optionally, the optimization process 100 estimates and/or assesses one or more predicted decisions which are decision(s) that may be taken during the runtime of the process execution. The predicted decision(s) may be used to derive values for one or more adjustable state variables making them adjusted variables. The adjusted variable(s) may be applied back into the designated optimization function to further improve the robustness of the optimization function and hence the calculated optimal solution. The prediction may be done by the optimization function designation module 202 coupled with the adjustment recognition module 206 and/or the optimization function tuning module 208.

Some embodiments of the present disclosure are provided through examples. However, this invention may be embodied in many different forms and should not be construed as limited to any specific structure or function presented herein.

While the example provided herein relates to a design scheduling optimization problem, the optimization process 100 may be applied to calculate a solution for a large class of practical optimization problems which may be formulated as a MILP problem, for example, system and system of system(s) design with mapping functional requirements to physical architecture, resource allocation and scheduling, reliability and timing calculations, power and data flow and the likes.

The exemplary design scheduling optimization problem presents a system that contains one processor and must complete J tasks within a predefined threshold processing time tₘₐₓ. The processing time may be reduced by providing additional power to processor. This additional power may not exceed a predefined power threshold pₘₐₓ. According to the process 100 some of the uncertainty adjustable state variables may be decision dependent, for example, the sequence of tasks execution and the amount of additional power supplied to processor during each task. The optimization process hence relies on a realization sequence (path) of the execution of the tasks J by the processor. The design goal is to minimize total power supplied to processor while the solution space must reside within the constraints imposed on the problem. The design scheduling optimization problem may be formulated as a MILP problem which is expressed through the equation set 1 below.

$$\begin{matrix}Equation set 1 \text{:} & \\ {s}_{i} \geq {s}_{j} + {t}_{j} - ( 1 - {x}_{ij} ) L ∀ i , j & ( 1 a ) \\ {t}_{j} = {\hat{t}}_{j} - {p}_{j} {δ}_{j} ∀ j & ( 1 b ) \\ {p}_{j} \leq {p}_{max} ∀ j & ( 1 c ) \\ {s}_{j} + {t}_{j} \leq {t}_{max} ∀ j & ( 1 d ) \\ {x}_{ij} + {x}_{ji} = 1 ∀ 1 , j & ( 1 e ) \\ {x}_{ij} ∈ \{ 0 , 1 \} ; {p}_{j} , {s}_{j} , {t}_{j} \geq 0 & ( 1 f ) \\ min totalPower = {\sum }_{j = 1. . J} {p}_{j} & ( 1 g )\end{matrix}$$

Where the problem parameters are: L is a large number, \hat{t}ⱼ is a maximal processing time for a task j, δⱼ is a reduction rate of processing (completion) time per power unit for the task j, pₘₐₓ is the maximal power available for providing the processor and tₘₐₓ is the maximal processing time for all the tasks J. And where the problem's variables are: sⱼ is a processing (completion) time of task j, tⱼ is a processing (completion) time for the task j, pⱼ is an amount of power provided to the processor for processing of the task j, xᵢⱼ is a decision of the sequence of execution, i.e. to perform a task i after the task j.

The processing time \hat{t}ⱼ of the task j is an uncertain variable with a nominal value Tⱼ⁰. The actual realization of \hat{t}ⱼ is dependent from Nⱼ task dependent uncertainty sources and can be represented as \hat{t}ⱼ=Tⱼ⁰+Σ_{n=1 . . . N}_{ⱼ}Tⱼⁿξⱼⁿ, where |ξⱼⁿ|≦1 is uncertainty realization and Tⱼⁿ is a basic shift for task j for uncertainty source n.

An AARC may therefore be created for the above uncertain MILP problem (presented in the equation set 1), where the adjustable decision is the amount of additional power supplied to the processor during each task j. While the adjustable decision may depend on particular realization of previous processing times tⱼ (of tasks which completed) it may not depend on future processing times tⱼ (of tasks which have are not completed yet) or this policy may not be implemented. The fact that no prior information on task processing sequence is available may present a major obstacle for the traditional AARC models which may result in conservative optimization solutions and/or even non-convergence of the solution. However when using the optimization process 100 to calculate the solution to the problem, the operation sequence information is a part of the solution of the optimization problem. The optimization process 100 however, may inject during the runtime the task processing sequence information into the information base of the AARC and as a result obtain a less conservative problem. Where the task processing sequence information may be revealed (become known) as result of one or more decision taken in runtime which may dictate the realization path of the processor processing sequence.

This may be achieved by defining the optimization problem variables pⱼ, sⱼ, tⱼ as adjustable variables. It should be noted that while pⱼ is a real decision variable, sⱼ, tⱼ are not real decision variables but are used as such to simplify the problem formulation and not to represented actual decision variables. The adjustable variables are therefore expressed as described in equation set 2 below.

$$\begin{matrix}Equation set 2 \text{:} & \\ {p}_{j} = {p}_{j}^{0} + {\sum }_{\begin{matrix}m = 1 \\ {x}_{j , m} = 1\end{matrix}}^{M = J} {\sum }_{n = 1}^{{N}_{m}} {p}_{j}^{n , m} {ζ}_{m}^{n} & ( 2 a ) \\ {s}_{j} = {s}_{j}^{0} + {\sum }_{m = 1}^{M = J} {\sum }_{n = 1}^{{N}_{m}} {s}_{j}^{n , m} {ζ}_{m}^{n} & ( 2 b ) \\ {p}_{j} = {p}_{j}^{0} + {\sum }_{\begin{matrix}m = 1 \\ {x}_{j , m} = 1\end{matrix}}^{M = J} {\sum }_{n = 1}^{{N}_{m}} {p}_{j}^{n , m} {ζ}_{m}^{n} & ( 2 c )\end{matrix}$$

While the definition of sⱼ,tⱼ are standard ARC definition and can be handled by standard ARC techniques, pⱼ may depend on decision of the processing sequence of the tasks J and hence may not be handled by the traditional ARC techniques. In order to utilize the decision dependent information a set of constraints presented in equation 3 below is added to the traditional ARC reformulation.

−x_{m,j}L≦pⱼ^{n,m}≦x_{m,j}L ∀n,m,j Equation 3:

Formulating the power pⱼ provided to the processor for processing each task j as a decision dependent variable may allow the optimization process 100 significant flexibility compared to the traditional (prior art) RO and/or AARC models where the pⱼ is non-adjustable since the tasks J processing sequence of uncertainty realization is unknown, i.e., making all pⱼ^{n,m} equal to zero.

The additional constraint of equation 3 together with the original constraints expressed in equation 1b, 1d and 1e above, the AARC of the optimization problem presented in the equation set 1 may now be represented as shown in equation set 4 below.

$$\begin{matrix}Equation set 4 \text{:} & \\ totalPower \geq {\sum }_{j = 1. . J} {p}_{j}^{0} + {\sum }_{j = 1}^{J} {\sum }_{m = 1}^{M = J} {\sum }_{n = 1}^{{N}_{m}} {\overline{p}}_{j}^{n , m} & ( 4 a ) \\ - {\overline{p}}_{j}^{n , m} \leq {p}_{j}^{n , m} \leq {\overline{p}}_{j}^{n , m} ∀ n , m , j & ( 4 b ) \\ {s}_{i}^{0} \geq {s}_{j}^{0} + {t}_{j}^{0} - ( 1 - {x}_{ij} ) L + {\sum }_{m = 1}^{M = J} {\sum }_{n = 1}^{{N}_{m}} {\overline{u}}_{1 , i , j}^{n , m} ∀ i , j & ( 4 c ) \\ - {\overline{u}}_{1 , i , j}^{n , m} \leq {s}_{j}^{n , m} - {s}_{i}^{n , m} + {t}_{j}^{n , m} \leq {\overline{u}}_{1 , i , j}^{n , m} ∀ n , m , i , j & ( 4 d ) \\ {t}_{j}^{0} = {T}_{j}^{0} - {p}_{j}^{0} {δ}_{j} ∀ j & ( 4 e ) \\ {t}_{j}^{n , m} = {T}_{j}^{n} - {p}_{j}^{n , m} {δ}_{j} ∀ n , m , j & ( 4 f ) \\ {p}_{j}^{0} + {\sum }_{m = 1}^{M = J} {\sum }_{n = 1}^{{N}_{m}} {\overline{p}}_{j}^{n , m} \leq {p}_{max} ∀ j & ( 4 g ) \\ {s}_{j}^{0} + {t}_{j}^{0} + {\sum }_{m = 1}^{M = J} {\sum }_{n = 1}^{{N}_{m}} {\overline{u}}_{j}^{n , m} \leq {t}_{max} ∀ j & ( 4 h ) \\ - {\overline{u}}_{2 , j}^{n , m} \leq {s}_{j}^{n , m} + {t}_{j}^{n , m} \leq {\overline{u}}_{2 , j}^{n , m} & ( 4 i ) \\ - {x}_{m , j} L \leq {p}_{j}^{n , m} \leq {x}_{m , j} L ∀ n , m , j & ( 4 j ) \\ {x}_{ij} + {x}_{ji} = 1 ∀ i , j & ( 4 k ) \\ {p}_{j}^{0} - {\sum }_{m = 1}^{M = J} {\sum }_{n = 1}^{{N}_{m}} {\overline{p}}_{j}^{n , m} \geq 0 & ( 4 l ) \\ - {\overline{s}}_{j}^{n , m} \leq {s}_{j}^{n , m} \leq {\overline{s}}_{j}^{n , m} ∀ n , m , j & ( 4 m ) \\ {s}_{j}^{0} - {\sum }_{m = 1}^{M = J} {\sum }_{n = 1}^{{N}_{m}} {\overline{s}}_{j}^{n , m} \geq 0 & ( 4 n ) \\ - {\overline{t}}_{j}^{n , m} \leq {t}_{j}^{n , m} \leq {\overline{t}}_{j}^{n , m} ∀ n , m , j & ( 4 o ) \\ {t}_{j}^{0} - {\sum }_{m = 1}^{M = J} {\sum }_{n = 1}^{{N}_{m}} {\overline{t}}_{j}^{n , m} \geq 0 & ( 4 p ) \\ {x}_{ij} ∈ \{ 0 , 1 \} ; & ( 4 q )\end{matrix}$$

The formulation of the optimization problem as presented in the equations set 4 where the adjustable state variable(s) is transformed to the decision dependent variable(s) to dictate a realization of the tasks J processing path may significantly improve the optimization solution value compared to the traditional optimization models such as the RO, ARC and/or AARC models. Moreover, the optimization process 100 may provide feasible optimization solutions for optimization problems that the traditional optimization models may find an empty solution space since the uncertainty realization path of the task processing sequence is unknown.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

It is expected that during the life of a patent maturing from this application many relevant systems, methods and computer programs will be developed and the scope of the term commerce information and price is intended to include all such new technologies a priori.

As used herein the term “about” refers to ±10%.

The terms “comprises”, “comprising”, “includes”, “including”, “having” and their conjugates mean “including but not limited to”. This term encompasses the terms “consisting of” and “consisting essentially of”.

The phrase “consisting essentially of” means that the composition or method may include additional ingredients and/or steps, but only if the additional ingredients and/or steps do not materially alter the basic and novel characteristics of the claimed composition or method.

As used herein, the singular form “a”, “an” and “the” include plural references unless the context clearly dictates otherwise. For example, the term “a compound” or “at least one compound” may include a plurality of compounds, including mixtures thereof.

The word “exemplary” is used herein to mean “serving as an example, instance or illustration”. Any embodiment described as “exemplary” is not necessarily to be construed as preferred or advantageous over other embodiments and/or to exclude the incorporation of features from other embodiments.

The word “optionally” is used herein to mean “is provided in some embodiments and not provided in other embodiments”. Any particular embodiment of the invention may include a plurality of “optional” features unless such features conflict.

Throughout this application, various embodiments of this invention may be presented in a range format. It should be understood that the description in range format is merely for convenience and brevity and should not be construed as an inflexible limitation on the scope of the invention. Accordingly, the description of a range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6 etc., as well as individual numbers within that range, for example, 1, 2, 3, 4, 5, and 6. This applies regardless of the breadth of the range.

Whenever a numerical range is indicated herein, it is meant to include any cited numeral (fractional or integral) within the indicated range. The phrases “ranging/ranges between” a first indicate number and a second indicate number and “ranging/ranges from” a first indicate number “to” a second indicate number are used herein interchangeably and are meant to include the first and second indicated numbers and all the fractional and integral numerals there between.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable subcombination or as suitable in any other described embodiment of the invention. Certain features described in the context of various embodiments are not to be considered essential features of those embodiments, unless the embodiment is inoperative without those elements.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention. To the extent that section headings are used, they should not be construed as necessarily limiting.

What is claimed is:

1. A computer implemented method of optimizing an execution of a process by applying adjustable robust optimization, comprising:
using at least one hardware processor adapted to:
designate an optimization function for calculating an optimal solution for a process execution comprising a plurality of ordered events, said process execution depends on a plurality of uncertain variables;
identify an adjustment which sets a value for at least one adjusted variable of said plurality of uncertain variables, said adjustment is derived from at least one decision made by a user, said at least one decision defines an order of at least one of said ordered events to execute a particular realization of said process execution;
apply said at least one adjusted variable to said optimization function which calculates said optimal solution; and
output said optimal solution to said user.

2. The computer implemented method of claim 1, wherein each of said plurality of uncertain variables is defined with a probability value.

3. The computer implemented method of claim 1, wherein said optimized solution resides within a set of pre-defined constraints.

4. The computer implemented method of claim 1, wherein said optimization function is calculated using at least one robust optimization model.

5. The computer implemented method of claim 1, further comprising improving a robustness of said optimization function by applying at least one predicted adjusted variable to said optimization function, said at least one predicted adjusted variable is derived from at least one simulated realization of said process execution.

6. A system of optimizing an execution of a process by applying adjustable robust optimization, comprising:
an interface for communicating with a user;
a program store storing a code; and
at least one processor coupled to said interface and said program store for executing said stored code, said code comprising:
code instructions for designating an optimization function for calculating an optimal solution for a process execution comprising a plurality of ordered events, said process execution depends on a plurality of uncertain variables;
code instructions for identifying an adjustment which sets a value for at least one adjusted variable of said plurality of uncertain variables, said adjustment is derived from at least one decision made by a user, said at least one decision defines an order of at least one of said ordered events to execute a particular realization of said process execution;
code instructions for applying said at least one adjusted variable to said optimization function which calculates said optimal solution; and
code instructions for outputting said optimal solution to said user.

7. The system of claim 6, wherein each of said plurality of uncertain variables is defined with a probability value.

8. The system of claim 6, wherein said optimized solution resides within a set of pre-defined constraints.

9. The system of claim 6, wherein said optimization function is calculated using at least one robust optimization model.

10. The system of claim 6, further comprising code instructions for improving a robustness of said optimization function by applying at least one predicted adjusted variable to said optimization function, said at least one predicted adjusted variable is derived from at least one simulated realization of said process execution.

11. A computer program product for optimizing an execution of a process by applying adjustable robust optimization, comprising:
a non-transitory computer readable storage medium;
first program instructions to designate an optimization function for calculating an optimal solution for a process execution comprising a plurality of ordered events, said process execution depends on a plurality of uncertain variables;
second program instructions to identify an adjustment which sets a value for at least one adjusted variable of said plurality of uncertain variables, said adjustment is derived from at least one decision made by a user, said at least one decision defines an order of at least one of said ordered events to execute a particular realization of said process execution;
third program instructions to apply said at least one adjusted variable to said optimization function which calculates said optimal solution; and
fourth program instructions to output said optimal solution to said user;
wherein said first, second, third and fourth program instructions are executed by at least one processor from said non-transitory computer readable storage medium.

12. The computer program product of claim 11, wherein each of said plurality of uncertain variables is defined with a probability value.

13. The computer program product of claim 11, wherein said optimized solution resides within a set of pre-defined constraints.

14. The computer program product of claim 11, wherein said optimization function is calculated using at least one robust optimization model.

15. The computer program product of claim 11, further comprising fifth program instructions to improve a robustness of said optimization function by applying at least one predicted adjusted variable to said optimization function, said at least one predicted adjusted variable is derived from at least one simulated realization of said process execution;
wherein said fifth program instructions are executed by at least one processor from said non-transitory computer readable storage medium.
